(19) United States
(12) Patent Application Publication
(10) Pub. No.: US 2011/0173070 A1
(43) Pub. Date: Jul. 14, 2011

(54) SERVICE SYSTEM AND METHOD FOR PROVIDING DETAILED MEMBER SHOP INFORMATION USING CARD TRANSACTION APPROVAL INFORMATION

(76) Inventor: Sung-Hwan Joo, Seoul (KR)

(21) Appl. No.: 13/120,651

(22) PCT Filed: Sep. 29, 2009
(86) PCT No.: PCT/KR09/05558

§ 371 Date: Mar. 23, 2011

(30) Foreign Application Priority Data
Sep. 29, 2008 (KR) 10-2008-0095585

(51) Int. Cl. G06Q 30/00; G06Q 40/00

(52) U.S. Cl. 705/14.53; 705/44

(57) ABSTRACT

Provided are a system for service of providing franchise details using card transaction approval information and a method thereof. When payment information is received from a franchise terminal, an authentication server approves a transaction by referencing a subscriber DB, and a forwarding server forwards card transaction statement information including an icon for a guide to the franchise details to a subscriber terminal which has been previously registered for the subscriber approved by the authentication server. When the subscriber terminal selects the icon, a franchise information management server reads the franchise details including a location and an advertisement of a franchise from a franchise information DB and transmits the franchise details to the subscriber terminal via the forwarding server. Thus, a location, an address, a telephone number, homepage information, advertisement information, and the like of the franchise are delivered to a user in a credit card transaction, thereby preventing piracy of a credit card and enabling the user to deliver received franchise information to others or to use the information for a variety of services.

### CROSS-REFERENCE TO RELATED APPLICATION

This application claims priority to and the benefit of Korean Patent Application No. 10-2008-0095585, filed on Sep. 29, 2008, the disclosure of which is incorporated herein by reference in its entirety.

### BACKGROUND

1. Field of the Invention

The present invention relates to a credit card approval transaction, and more particularly, to a system for service of providing franchise details including a location and an advertisement of a franchise using card transaction approval information, and a method thereof.

2. Discussion of Related Art

In general, people use a variety of services in ordinary life. For example, they receive a variety of services such as a mobile telephone service, a beauty shop service, a barber shop service, and a bakery service, and pay fees for the services. A credit card is mainly used for payment. When such a credit card is pirated, a user may suffer.

For example, a user can know only a name of a franchise from a statement of card use after directly using his or her credit card. However, when a family member or a third party uses such a credit card, the user cannot know exact franchise information. Further, it is difficult for the user to go to the franchise since the user does not know a location of the franchise to which the user wants to go.

Thus, it is necessary for a credit card user to know details of credit card franchises.

### SUMMARY OF THE INVENTION

The present invention is directed to delivery of a location, an address, a telephone number, homepage information, an advertisement, and the like of a franchise to a user in a credit card transaction to prevent piracy of a credit card and enable the user to use received franchise information for a variety of services.

According to an aspect of the present invention, there is provided a system for service of providing franchise details using card transaction approval information, the system receiving a statement of card use of a subscriber from a franchise terminal to perform authentication, wherein the system includes: a subscriber database (DB) for storing subscriber information; a franchise information DB for storing the franchise details including a location of a franchise; an authentication server for approving a transaction by referencing the subscriber DB when payment information is received from the franchise terminal; a forwarding server for transmitting card transaction statement information to a subscriber terminal which has been previously registered for the subscriber approved by the authentication server, the card transaction statement information including an icon for a guide to the franchise details; and a franchise information management server for transmitting the franchise details including the location of the franchise to the subscriber terminal via the forwarding server when the subscriber terminal selects the icon.

According to another aspect of the present invention, there is provided a system for service of providing franchise details using card transaction approval information, the system receiving a statement of card use of a subscriber from a franchise terminal to perform authentication, wherein the system includes: a subscriber DB for storing subscriber information; a franchise information DB for storing the franchise details including a location and an advertisement of a franchise; an authentication server for approving a transaction by referencing the subscriber DB when payment information is received from the franchise terminal; a forwarding server for transmitting card transaction statement information to a subscriber terminal which has been previously registered for the subscriber approved by the authentication server, the card transaction statement information including an icon for a guide to the franchise details; and a franchise information management server for reading the franchise details including the location and the advertisement of the franchise from the franchise information DB and transmitting the franchise details to the subscriber terminal via the forwarding server when the subscriber terminal selects the icon.

According to yet another aspect of the present invention, there is provided a method for service of providing franchise details using card transaction approval information, in which a statement of card use of a subscriber is received from a franchise terminal to perform authentication, and a subscriber DB for storing subscriber information and a franchise information DB for storing the franchise details including a location and an advertisement of a franchise are included, the method including: approving, by an authentication server, a transaction by referencing the subscriber DB when payment information is received from the franchise terminal; transmitting, by a forwarding server, card transaction statement information to a subscriber terminal which has been previously registered for the subscriber approved by the authentication server, the card transaction statement information including an icon for a guide to the franchise details; and reading, by a franchise information management server, the franchise details including the location and the advertisement of the franchise from the franchise information DB and transmitting the franchise details to the subscriber terminal via the forwarding server when the subscriber terminal selects the icon.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 is a diagram showing a configuration of a system for service of providing franchise details using card transaction approval information according to an embodiment of the present invention; and

FIG. 2 is a flowchart showing operation of a method for service of providing franchise details using card transaction approval information according to an embodiment of the present invention.

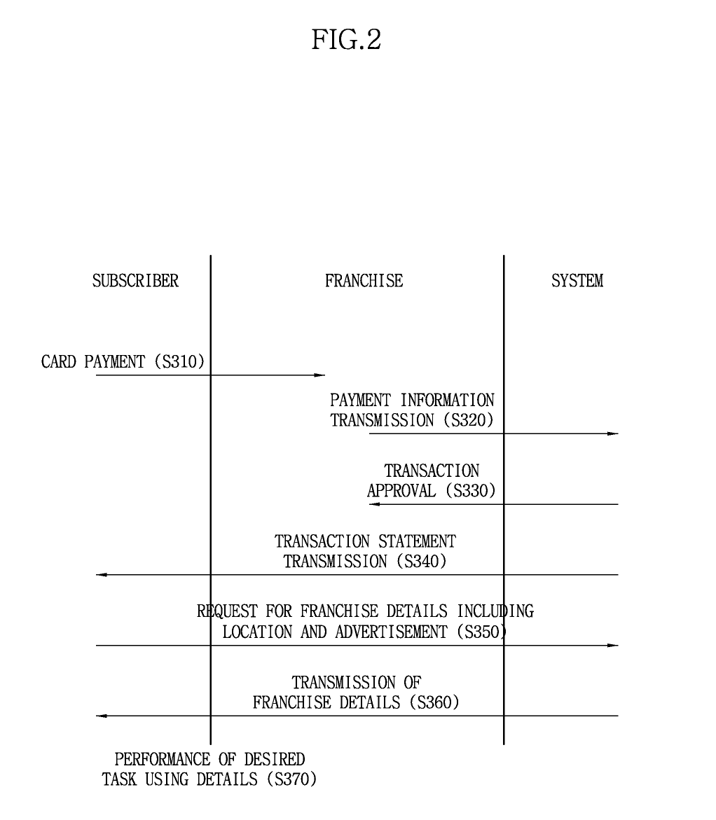

### DETAILED DESCRIPTION OF EXEMPLARY EMBODIMENTS

Exemplary embodiments of the present invention are disclosed herein. However, specific structural and functional details disclosed herein are merely representative for purposes of describing exemplary embodiments of the present invention, however, exemplary embodiments of the present invention may be embodied in many alternate forms and should not be construed as limited to exemplary embodiments of the present invention set forth herein. Like reference numerals in the drawings denote like elements.

Throughout this disclosure, when a part is referred to as including a component, this does not preclude the presence or addition of other components, but other components may be included unless specifically mentioned otherwise.

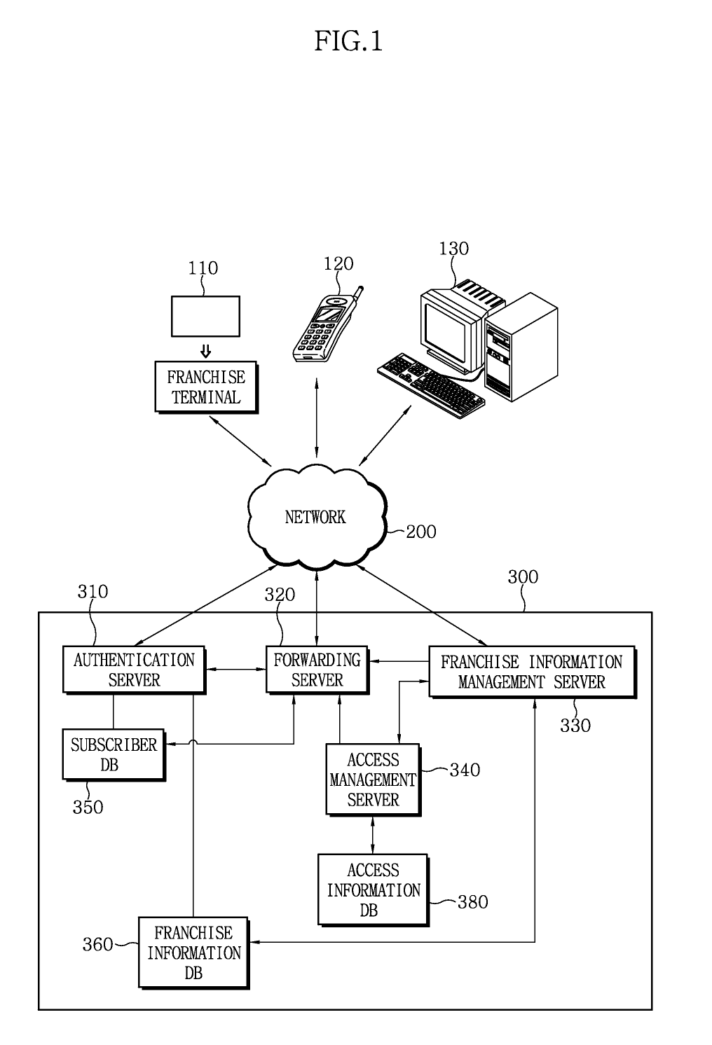

FIG. 1 is a diagram showing a configuration of a system for service of providing franchise details using card transaction approval information according to an embodiment of the present invention. The system includes a subscriber database (DB) 350, a franchise information DB 360, an access information DB 380, an authentication server 310, a forwarding server 320, a franchise information management server 330, and an access management server 340.

Subscriber information, such as personal information of a subscriber and a telephone number and an e-mail address for a subscriber terminal that will receive a transaction statement, is stored in the subscriber DB 350.

Franchise details including a location, an advertisement, a map, a discount coupon, homepage information, a telephone number, and the like of a franchise is stored in the franchise information DB 360.

Statistical information about how many subscribers having received card transaction statement information have requested the franchise details is stored in the access information DB 380.

When payment information is received from a franchise terminal, the authentication server 310 approves a transaction by referencing the subscriber DB 350 and causes the forwarding server 320 to forward the card transaction statement information.

The forwarding server 320 transmits the card transaction statement information including an icon for a guide to the franchise details to a subscriber terminal which has been previously registered for a subscriber approved by the authentication server 310. The information may be transmitted, for example, using a short message service (SMS) or an e-mail.

When the subscriber terminal 120 or 130 selects the icon included in the card transaction statement information to request the franchise details, the franchise information management server 330 reads the franchise details including a location and an advertisement of the franchise from the franchise information DB and transmits the franchise details to the subscriber terminal via the forwarding server.

The access management server 340 stores statistical information about how many subscribers having received the card transaction statement information forwarded by the forwarding server 320 have requested the franchise details through the franchise information management server 330, in the access information DB 380.

Operation of the system for service of providing franchise details using card transaction approval information according to an embodiment of the present invention will now be described in detail.

A franchise owner registers franchise details including a location, an advertisement, a discount coupon, homepage information, a telephone number, and the like of his or her franchise, for example, using his or her computer in advance.

In this state, a subscriber or a third party wants to use a subscriber's credit card for payment, and the franchise owner reads the credit card to transmit payment information to the authentication server 310 using the franchise terminal 400.

Upon receipt of the payment information from the franchise terminal, the authentication server 310 then approves a transaction by referencing the subscriber DB 350 and causes the forwarding server 320 to forward card transaction statement information.

The forwarding server 320 transmits the card transaction statement information including an icon for a guide to franchise details to a subscriber terminal which has been previously registered for the subscriber approved by the authentication server 310. The information may be transmitted using an SMS or an e-mail.

The user then views the card transaction statement information displayed on the terminal 120 or 130, and selects the icon to request the franchise details when wanting to obtain the franchise details.

The franchise information management server 330 then receives the request for the franchise details from the subscriber terminal 120 or 130, reads the franchise details including a location, an advertisement, a discount coupon, homepage information, a telephone number, and the like of the franchise from the franchise information DB 360, and transmits the franchise details to the subscriber terminal 120 or 130 via the forwarding server 320. The franchise details may be in the form of a business card or in other forms.

Meanwhile, the access management server 340 stores statistical information about how many subscribers having received the card transaction statement information forwarded by the forwarding server 320 have requested the franchise details through the franchise information management server 330, in the access information DB 380. This statistical information may be used as statistical data indicating which franchise provides more franchise details. The statistical data may be provided to franchises.

The subscriber terminal 120 or 130 may obtain more information by accessing a homepage or viewing the advertisement using the received franchise details, and judge whether the user's credit card has been pirated or not.

Further, the subscriber may deliver location information to a navigation terminal to visit the franchise or deliver the franchise details to his or her acquaintance to recommend the franchise.

According to the embodiment of the present invention, a location, an address, a telephone number, homepage information, an advertisement, and the like of a franchise are delivered to a user in a credit card transaction, thereby preventing piracy of a credit card and enabling the user to deliver received franchise information to others or to use the information for a variety of services.

The above-described embodiment of the present invention is not embodied only by an apparatus and a method, but may be embodied by a program realizing functionality corresponding to the configuration of the embodiment of the present invention or a recording medium having the program recorded thereon. This may be easily performed by those skilled in the art from the above-described embodiment.

It will be apparent to those skilled in the art that various modifications can be made to the above-described exemplary embodiments of the present invention without departing from the spirit or scope of the invention. Thus, it is intended that the present invention covers all such modifications provided they come within the scope of the appended claims and their equivalents.

What is claimed is:

1. A system for service of providing franchise details using card transaction approval information, the system receiving a statement of card use of a subscriber from a franchise terminal to perform authentication, wherein the system comprises:
a subscriber database (DB) for storing subscriber information;
a franchise information DB for storing the franchise details including a location of a franchise;
an authentication server for approving a transaction by referencing the subscriber DB when payment information is received from the franchise terminal;
a forwarding server for transmitting card transaction statement information to a subscriber terminal which has been previously registered for the subscriber approved by the authentication server, the card transaction statement information including an icon for a guide to the franchise details; and
a franchise information management server for transmitting the franchise details including the location of the franchise to the subscriber terminal via the forwarding server when the subscriber terminal selects the icon.

2. The system according to claim 1, wherein the franchise details further include at least one of an advertisement, a discount coupon, a map, homepage information, and a telephone number of the franchise.

3. The system according to claim 1, further comprising:
an access information DB for storing statistical information about how many subscribers having received the card transaction statement information have requested the franchise details; and
an access management server for storing statistical information about how many subscribers having received the card transaction statement information forwarded by the forwarding server have requested the franchise details through the franchise information management server, in the access information DB.

4. The system according to claim 2, further comprising:
an access information DB for storing statistical information about how many subscribers having received the card transaction statement information have requested the franchise details; and
an access management server for storing statistical information about how many subscribers having received the card transaction statement information forwarded by the forwarding server have requested the franchise details through the franchise information management server, in the access information DB.

5. A system for service of providing franchise details using card transaction approval information, the system receiving a statement of card use of a subscriber from a franchise terminal to perform authentication, wherein the system comprises:
a subscriber DB for storing subscriber information;
a franchise information DB for storing the franchise details including a location and an advertisement of a franchise;
an authentication server for approving a transaction by referencing the subscriber DB when payment information is received from the franchise terminal;
a forwarding server for transmitting card transaction statement information to a subscriber terminal which has been previously registered for the subscriber approved by the authentication server, the card transaction statement information including an icon for a guide to the franchise details; and
a franchise information management server for reading the franchise details including the location and the advertisement of the franchise from the franchise information DB and transmitting the franchise details to the subscriber terminal via the forwarding server when the subscriber terminal selects the icon.

6. The system according to claim 5, further comprising:
an access information DB for storing statistical information about how many subscribers having received the card transaction statement information have requested the franchise details; and
an access management server for storing statistical information about how many subscribers having received the card transaction statement information forwarded by the forwarding server have requested the franchise details through the franchise information management server, in the access information DB.

7. A method for service of providing franchise details using card transaction approval information, in which a statement of card use of a subscriber is received from a franchise terminal to perform authentication, and a subscriber DB for storing subscriber information and a franchise information DB for storing the franchise details including a location and an advertisement of a franchise are included, the method comprising:
approving, by an authentication server, a transaction by referencing the subscriber DB when payment information is received from the franchise terminal;
transmitting, by a forwarding server, card transaction statement information to a subscriber terminal which has been previously registered for the subscriber approved by the authentication server, the card transaction statement information including an icon for a guide to the franchise details; and
reading, by a franchise information management server, the franchise details including the location and the advertisement of the franchise from the franchise information DB and transmitting the franchise details to the subscriber terminal via the forwarding server when the subscriber terminal selects the icon.

8. The method according to claim 7, wherein the franchise details further include at least one of a discount coupon, homepage information, a map, and a telephone number of the franchise.

9. The method according to claim 7, further comprising storing, by an access management server, statistical information about how many subscribers having received the card transaction statement information forwarded by the forwarding server have requested the franchise details through the franchise information management server, in the access information DB.

10. The method according to claim 8, further comprising storing, by an access management server, statistical information about how many subscribers having received the card transaction statement information forwarded by the forwarding server have requested the franchise details through the franchise information management server, in the access information DB.
